(19) United States
(12) Patent Application Publication
(10) Pub. No.: US 2017/0255206 A1
(43) Pub. Date: Sep. 7, 2017

(54) ANTI-COLLISION SYSTEM FOR UNMANNED AERIAL VEHICLE AND METHOD THEREOF

(71) Applicant: Chicony Electronics Co., Ltd., New Taipei City (TW)

(72) Inventors: Tsung-Sheng CHEN, New Taipei City (TW); Shang-Yuan YUAN, New Taipei City (TW)

(21) Appl. No.: 15/213,371

(22) Filed: Jul. 18, 2016

(30) Foreign Application Priority Data
Mar. 7, 2016 (CN) 201610126931.5

(51) Int. Cl. G05D 1/10; H04W 4/02; G05D 1/00; B64C 39/02; G01S 19/14; H04B 17/318; H04W 4/00

(52) U.S. Cl. CPC G05D 1/104; H04B 17/318; H04W 4/023; H04W 4/027; H04W 4/026; H04W 4/008; B64C 39/024; G01S 19/14; G05D 1/0011

(57) ABSTRACT

An anti-collision system for an UAV and a method thereof are provided. The anti-collision system for an UAV includes: a first aerial vehicle. The first aerial vehicle includes: a wireless transmission module and a processor. The wireless transmission module is used for transmitting a first signal of the first aerial vehicle and for receiving a second signal from a second aerial vehicle; the processor is used for calculating a signal strength of the second signal, for obtaining a spacing distance between the second aerial vehicle and the first aerial vehicle, to determine if the spacing distance is less than a distance threshold value; wherein when the spacing distance is less than the distance threshold value, the processor adjusts a flight status of the first aerial vehicle. Thus the present invention can avoid the collisions between the first aerial vehicle and the second aerial vehicle.

### RELATED APPLICATIONS

This application claims priority to China Application Serial Number 201610126931.5, filed Mar. 7, 2016, which is herein incorporated by reference.

### BACKGROUND

Field of Invention

The present invention relates to an anti-collision system for an Unmanned Aerial Vehicle (UAV) and a method thereof. More particularly, the present invention relates to a system for aerial photography UAVs to avoid collision with other UAVs, and a method thereof.

Description of Related Art

Recently, UAV's fields of applications are becoming broader, UAVs can be used for military, commercial or leisure purposes, for example, the users may use an UAV with a photograph function (e.g., a drone) to shoot at high altitude for obtaining image data required by the users. Advantages of the UAVs include low cost, and the ability to replace humane in the performance of highly dangerous missions, so the importance of UAVs is irreplaceable.

However, when a plurality of UAVs executes aerial photography, it may cause collisions of the UAVs due to the crossing of paths. Therefore, it is important for the fields to make multiple UAVs communicate with each other during flights, and to avoid collisions of multiple UAVs in midair.

### SUMMARY

One object of the present disclosure is to provide an anti-collision system for an UAV. The anti-collision system for the UAV includes: a first aerial vehicle. The first aerial vehicle includes a wireless transmission module and a processor. The wireless transmission module is for transmitting a first signal of the first aerial vehicle and for receiving a second signal from a second aerial vehicle; and the processor is for calculating a signal strength of the second signal to obtain a spacing distance between the first aerial vehicle and the second aerial vehicle, and determining whether the spacing distance is less than a distance threshold value; wherein when the spacing distance is less than the distance threshold value, the processor adjusts a flight status of the first aerial vehicle.

Another object of the present disclosure is to provide an anti-collision method for an UAV. The anti-collision method for the UAV including: transmitting a first signal of a first aerial vehicle and receiving a second signal from a second aerial vehicle; and calculating a signal strength of the second signal to obtain a spacing distance between the first aerial vehicle and the second aerial vehicle, and determining whether the spacing distance is less than a distance threshold value; when the spacing distance is less than the distance threshold value, adjusting a flight status of the first aerial vehicle.

In summary, by detecting the flying distances according to the signal strength, the present invention can adjust the flight path of at least one aerial vehicle when the flying spacing between two aerial vehicles is too small to thereby prevent the collision of the two aerial vehicles from occurring.

### BRIEF DESCRIPTION OF THE DRAWINGS

The invention can be more fully understood by reading the following detailed description of the embodiment, with reference made to the accompanying drawings as follows:

FIG. 1 is a flow chart of an anti-collision method of an UAV according to an exemplary embodiment of the present invention;

FIG. 2 is a block diagram of an aerial vehicle according to an exemplary embodiment of the present invention;

FIG. 3A and FIG. 3B are diagrams respectively illustrating the anti-collision method of aerial vehicles according to an exemplary embodiment of the present invention;

FIG. 4 is a flow chart of the anti-collision method of the UAV according to an exemplary embodiment of the present invention; and

FIG. 5 is a block diagram of the aerial vehicle according to an exemplary embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. Certain terms are used throughout the following description and claims, which refer to particular components. As one skilled in the art will appreciate, electronic equipment manufacturers may refer to a component by different names. This document does not intend to distinguish between components that differ in name but not in function.

As used herein, “about”, “approximately” or “around” describe amounts which are subject to slight variations in the actual value but such variations do not have material impact. Unless otherwise noted in the embodiment, the amounts described by “about”, “around” or “approximately” typically have a level of tolerance of under twenty percent, or, better, under ten percent, or, better still, under five percent.

In the following description and in the claims, the terms “include” and “comprise” are used in an open-ended fashion, and thus should be interpreted to mean “include, but not limited to . . . .” Also, the term “couple” is intended to mean either an indirect or direct electrical connection. Accordingly, if one device is coupled to another device, that connection may be through a direct electrical connection, or through an indirect electrical connection via other devices and connections. The terms “first”, “second”, . . . etc., in the article do not refer to any specific order, nor intended to limit the present invention, it is only used for distinguishing the differences between components or operations with the same technological descriptions. The term “couple” or “connected” is intended to mean two or more elements are either an indirect or direct electrical connection, while “coupled” may also refers to two or more elements can control or operate each other.

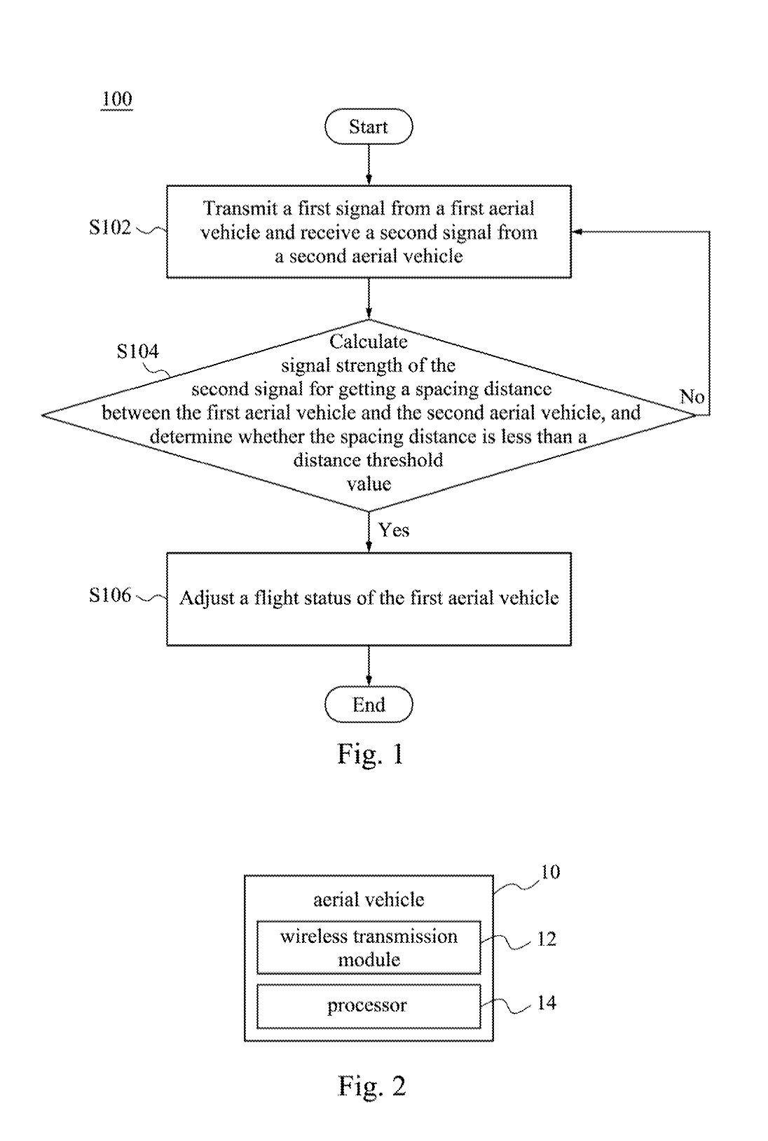

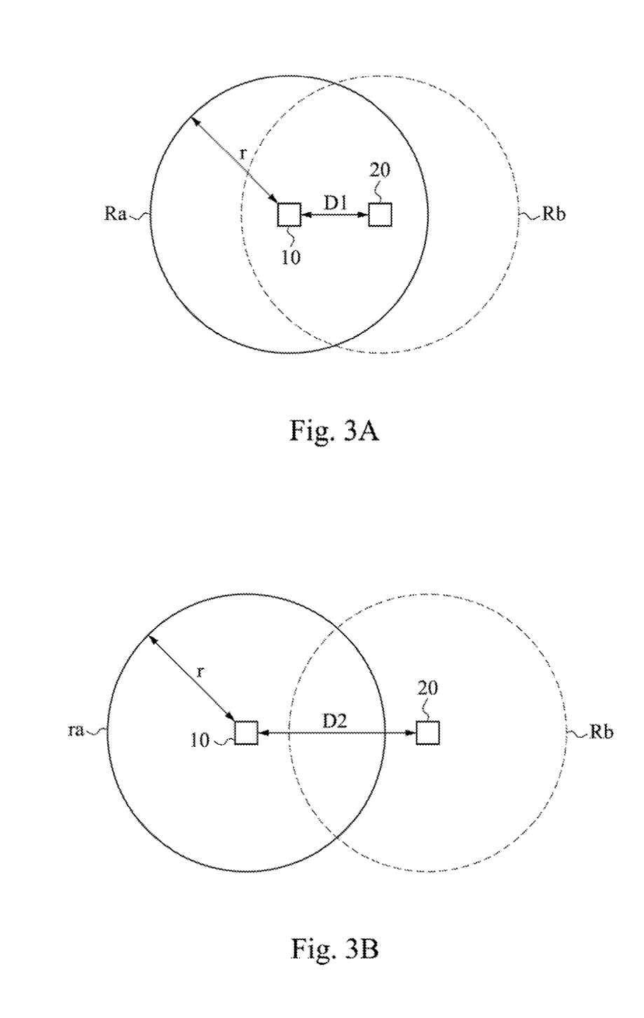

Please refer to FIG. 1, FIG. 2, FIG. 3A and FIG. 3B. FIG. 1 is a flow chart of an anti-collision method 100 of an UAV according to an exemplary embodiment of the present invention. FIG. 2 is a block diagram of an aerial vehicle 10 according to an exemplary embodiment of the present invention. FIG. 3A and FIG. 3B are diagrams respectively illustrating the anti-collision method of aerial vehicles 18 and 20 according to an exemplary embodiment of the present invention.

The anti-collision system for the UAV includes at least an aerial vehicle, such as the aerial vehicle 10 and/or the aerial vehicle 20 in FIG. 3A. In an exemplary embodiment, the aerial vehicles 10, 20 can be UAVs, such as fixed-wing aircrafts, quadcopter aircrafts, rotary wing aircraft or aerial photography UAVs.

As shown in FIG. 2, the aerial vehicle 10 includes a wireless transmission module 12 and a processor 14. In practical applications, the processor 14 can also be implemented by a microcontroller, a microprocessor, a digital signal processor, an Application Specific Integrated Circuit (ASIC), or by a logic circuit. Besides, the wireless transmission module 12 can be implemented by a Bluetooth transmission module or by other wireless transmission manners. For instance, the wireless transmission module 12 can be implemented by a signal broadcasting module (e.g., iBeacon) based on Bluetooth Low Energy (BLE). In an exemplary embodiment, the aerial vehicle 20 and the aerial vehicle 10 have the same or similar components.

As shown in FIG. 1, the anti-collision method of the UAV executes the step S102, the aerial vehicle 10 transmits the first signal and receives the second signal from the aerial vehicle 20 via the wireless transmission module 12.

In an exemplary embodiment, as shown in FIG. 3A, the wireless transmission module 12 of the aerial vehicle 10 has a transmission range Ra, and a transmission radius of the transmission range Ra is r. For example, when the wireless transmission module 12 is a Bluetooth transmission module, the transmission radius r can be 30 m, hence all other aerial vehicles enter the transmission range Ra having the transmission radius r can receive the first signal transmitted from the aerial vehicle 10. On the other hand, the wireless transmission module 12 of the aerial vehicle 10 can also receive the signals from all the other aerial vehicles that are in the transmission range Ra having the transmission radius r.

For example, in FIG. 3A, there is a spacing distance D1 between the aerial vehicle 20 and the aerial vehicle 10, and the spacing distance D1 is less than the transmission radius r, that is, the aerial vehicle 20 is situated in the transmission range Ra of the wireless transmission module 12 of the aerial vehicle 10. Therefore, when the aerial vehicle 10 broadcasts the first signal via the wireless transmission module 12, the aerial vehicle 20 in the transmission range Ra can receive the first signal from the aerial vehicle 10. Similarly, the aerial vehicle 10 is situated in the transmission range Rb of the aerial vehicle 20; thereby it can receive the second signal from the aerial vehicle 20. In some exemplary embodiments, the magnitudes of the transmission ranges Ra, Rb of the aerial vehicle 10 and the aerial vehicle 20 are about the same.

In an exemplary embodiment, the aerial vehicle 10 can periodically broadcast the first signal via the wireless transmission module 12, all the other aerial vehicles entering the transmission range Ra can periodically receive the first signal from the aerial vehicle 10, and the aerial vehicle 20 can also periodically broadcast the second signal.

On the contrary, in FIG. 3B, the spacing distance between the aerial vehicle 20 and the aerial vehicle 10 is D2, the spacing distance D2 is larger than the transmission radius r. In this case, since the location of the aerial vehicle 20 exceeds the transmission range Ra of the wireless transmission module 12 of the aerial vehicle 10, the wireless transmission module 12 of the aerial vehicle 10 can't transmit the first signal to the aerial vehicle 20, and the wireless transmission module 12 of the aerial vehicle 10 can't receive the second signal from the aerial vehicle 20. Therefore, the aerial vehicle 10 and the aerial vehicle 20 can't exchange the first signal/second signal.

In an exemplary embodiment, the first signal includes an identification code of the aerial vehicle 10 and/or the Media Access Control (MAC) address of the aerial vehicle 10, in this way, the aerial vehicles receiving the first signal can identify that the first signal is from the aerial vehicle 10. On the other hand, the second signal can includes an identification code of the aerial vehicle 20 and/or the MAC address of the aerial vehicle 20, thus, the aerial vehicles receiving the second signal can identify that the second signal is from the aerial vehicle 20.

Afterwards, if the aerial vehicle 10 receives the second signal from the aerial vehicle 20 during the flight, as shown in FIG. 3A, when the aerial vehicle 10 enters the transmission range Rb of the aerial vehicle 20, the anti-collision method of the UAVs 100 executes the step S104, the aerial vehicle 10 calculates the signal strength of the received second signal by the processor 14, for obtaining the spacing distance D1 between the aerial vehicle 10 and the aerial vehicle 20 (as shown in FIG. 3A), and determines whether the spacing distance D1 is less than a distance threshold value (e.g., 30 m). When the processor 14 determines that the spacing distance D1 is less than the distance threshold value, the method executes the step S106. When the processor 14 determines that the spacing distance D1 is not less than the distance threshold value, the method returns to the step S102.

In an exemplary embodiment, the processor 14 of the aerial vehicle 10 can obtain the signal strength of the second signal by detecting the Received Signal Strength Indication (RSSI) of the second signal, and figures out the spacing distance D1 between the aerial vehicle 20 and the aerial vehicle 10 by the following formula.

$$D 1 = {10}^{\frac{\vert RSSI \vert - A}{{10}^{*} n}}$$

Wherein the symbol A represents the signal strength when the distance between the aerial vehicle 20 and the aerial vehicle 10 is 1 m, the symbol n represents the environmental attenuation factor, and RSSI is the signal strength of the second signal. In an exemplary embodiment, the wireless transmission module 12 is a Bluetooth transmission module, and the RSSI value of the second signal transmitted from the wireless transmission module 12 is around 0˜−100, the shorter the distance between the aerial vehicle 20 and the aerial vehicle 10, the larger the RSSI value, that is, the RSSI value will approach 0. In practice, each factor of the above formula should be got by tests or calibrations, however, in the situation that the precise locations of the wireless transmission modules of surrounding aerial vehicles are uncertain, the symbol A and the symbol n can be given respective predetermined experiential values. In this way, as shown in FIG. 3A, the processor 14 of the aerial vehicle 10 can detect the signal strength of the second signal from the aerial vehicle 20, for obtaining the spacing distance D1 between the aerial vehicle 20 and the aerial vehicle 10.

Besides, in an exemplary embodiment, each of the second signals periodically transmitted by the aerial vehicle 20 can include a timestamp, and the aerial vehicle 20 can periodically and continually transmit the second signal. As shown in FIG. 3A, when the spacing distance D1 between the aerial vehicle 10 and the aerial vehicle 20 is less than the distance threshold value (e.g., 30 m), and the signal strength increases along with the timestamp, it represents that the aerial vehicle 10 and the aerial vehicle 20 are getting closer to each other in space, thus the processor 14 of the aerial vehicle 10 can determine that the aerial vehicle 10 and the aerial vehicle 20 will collide, in this case, the aerial vehicle 10 can transmit a warning notification to the aerial vehicle 20 or other control platforms.

In the step S106, the processor 14 of the aerial vehicle 10 adjusts a flight status of the first aerial vehicle (e.g., the aerial vehicle 10). In an exemplary embodiment, the flight status includes the direction of travel and the traveling speed of the aerial vehicle 10.

As shown in FIG. 3A, when the spacing distance D1 between the aerial vehicle 10 and the aerial vehicle 20 is less than the distance threshold value, the processor 14 of the aerial vehicle 10 compares the magnitude of the identification code of the aerial vehicle 10 with that of the identification code of the aerial vehicle 20, to control the direction of travel and the traveling speed of the aerial vehicle 10.

In an exemplary embodiment, the aerial vehicle with larger identification code will be given the higher flight path priority. For instance, the identification code of the aerial vehicle 10 is 1000, and the identification code of the aerial vehicle 20 is 2000; when the spacing distance D1 between the aerial vehicle 10 and the aerial vehicle 20 is less than the distance threshold value, the processor of the aerial vehicle 10 will compares the magnitude of the identification codes of the aerial vehicle 10 and the aerial vehicle 20, and will give the aerial vehicle 20 with the larger identification code a higher flight path priority. Thus, when the spacing distance D1 between the aerial vehicle 10 and the aerial vehicle 20 is less than the distance threshold value, the processor 14 of the aerial vehicle 10 will adjust the direction of travel and the traveling speed of the aerial vehicle 10, and the aerial vehicle 20 with the higher flight path priority for the moment will not need to change the flight status thereof. For example, the processor 14 controls the aerial vehicle 10 to role around, to slow down or reverse the direction from the current flight path, while the aerial vehicle 20 remains the original direction of travel and the original traveling speed thereof.

In this step, it is not restricted to adjust a flight status of the first aerial vehicle (e.g., the aerial vehicle 10), it is allowed to only adjust the flight status of the second aerial vehicle (e.g., the aerial vehicle 20) according to the practical environment. For instance, when the identification code of the aerial vehicle 10 is larger than the identification code of the aerial vehicle 20, the aerial vehicle 10 will be given a higher flight path priority; therefore, when the spacing distance D1 between the aerial vehicle 10 and the aerial vehicle 20 is less than the distance threshold value, the aerial vehicle 20 will adjust the flight status thereof (such as to circle around, to slow down or reverse the direction from the current flight path), and the aerial vehicle 10 will keep the original direction of travel and the original travelling speed.

In another exemplary embodiment, when the spacing distance D1 between the aerial vehicle 10 and the aerial vehicle 20 is less than the distance threshold value, both of the aerial vehicle 10 and the aerial vehicle 20 will adjust the flight statuses, such as both will reverse the direction from the current flight paths.

In an exemplary embodiment, the distance threshold value can be set as less than or equal to the transmission radius r of the aerial vehicle 10, such as the distance threshold value can be preset as 10 m.

In another exemplary embodiment, when the spacing distance (such as the spacing distance D1) is less than the distance threshold value, the processor 14 of the aerial vehicle 10 compares the magnitude of the MAC address of the aerial vehicle 10 with that of the MAC address of the aerial vehicle 20, to control the direction of travel and the traveling speed of the aerial vehicle 10. In an exemplary embodiment, the aerial vehicle with larger MAC address will be given a higher flight path priority. For instance, when the spacing distance D1 between the aerial vehicle 10 and the aerial vehicle 20 is less than distance threshold value, the aerial vehicle 10 can receive the MAC address of the aerial vehicle 20, and the processor 14 of the aerial vehicle 10 can respectively use the MAC address of the aerial vehicle 10 and the MAC address of the aerial vehicle 20 as a random seed, and enter the two random seeds into a random generation formula, to generate a random value corresponding to the aerial vehicle 10, and another random value corresponding to the aerial vehicle 20, and compare the magnitudes of the two random values. For example, when the random value corresponding to the aerial vehicle 10 is less than the random value corresponding to the aerial vehicle 20, the processor 14 of the aerial vehicle 10 determines that the aerial vehicle 20 has a higher flight path priority. Thus, when the spacing distance D1 between the aerial vehicle 10 and the aerial vehicle 20 is less than the distance threshold value, the processor 14 of the aerial vehicle 10 will adjust the direction of travel and the traveling speed of the aerial vehicle 10, such as, the processor 14 of the aerial vehicle 10 controls the aerial vehicle 10 to circle around, to slow down, or reverse the direction from the current flight path, while the aerial vehicle 20 remains the original direction of travel and the original traveling speed; on the contrary, when the random value corresponding to the aerial vehicle 10 is larger than the random value corresponding to the aerial vehicle 20, the processor 14 of the aerial vehicle 10 determines the aerial vehicle with the larger random value a higher flight path priority.

In an exemplary embodiment, the wireless transmission module 12 of the aerial vehicle 10 is a Bluetooth transmission module. More particularly, the Bluetooth transmission module can be implemented by a signal broadcasting module base on BLE. In an exemplary embodiment, the Bluetooth transmission module of the aerial vehicle 10 is used for continuously or periodically broadcasting a Bluetooth signal, to make all the other aerial vehicles inside the transmission range Ra of the Bluetooth transmission module can receive the Bluetooth signal. On the other hand, the Bluetooth transmission module of the aerial vehicle 20 has a transmission range Rb, and the Bluetooth transmission module of the aerial vehicle 20 can continuously or periodically broadcast another Bluetooth signal, to make all the other aerial vehicles inside the transmission range Rb of the Bluetooth transmission module can receive the Bluetooth signal from the aerial vehicle 20. Therefore, when the aerial vehicle 10 is situated inside the transmission range Rb, the aerial vehicle 10 can receive the Bluetooth signal from the aerial vehicle 20.

In an exemplary embodiment, the processor 14 of the aerial vehicle 10 can calculate the spacing distance (e.g., the spacing distance D1) between the aerial vehicle 10 and the aerial vehicle 20 according to the signal strength of the other Bluetooth signal from the aerial vehicle 20.

By the above steps, the aerial vehicle 10 can make other adjacent aerial vehicles receive the Bluetooth signal from the aerial vehicle 10 by the manner of continuously or periodically broadcasting the Bluetooth signal, while the aerial vehicle 10 can also receive the Bluetooth signals from other aerial vehicles, and it is allowed to obtain the flight distances between the aerial vehicle 10 and multiple aerial vehicles by the signal strength of the received Bluetooth signals. When the flight distance between the aerial vehicle 10 and the aerial vehicle 20 is too short, at least one of the flight paths of the aerial vehicle 10 and the aerial vehicle 20 can be adjusted, for preventing the collision between the two aerial vehicles.

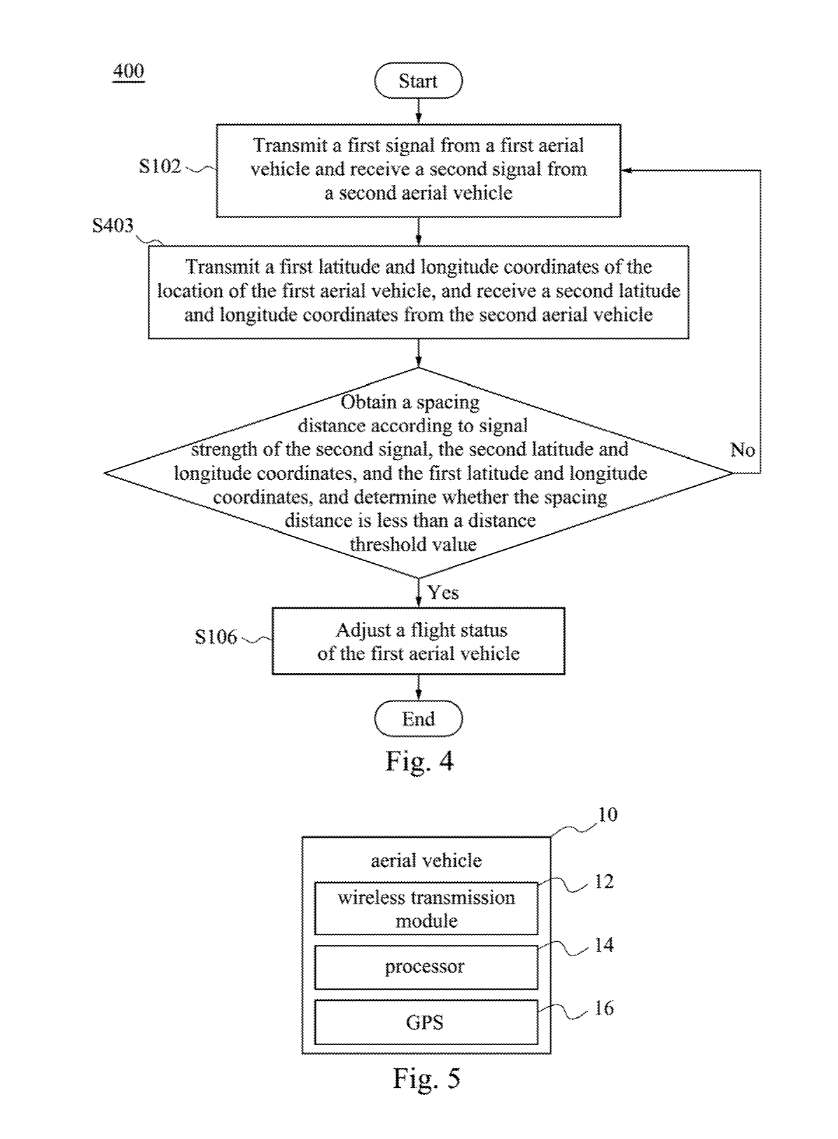

Please refer to FIG. 4 in conjunction with FIG. 5. FIG. 4 is a flow chart of the anti-collision method 400 of the UAV according to an exemplary embodiment of the present invention. FIG. 5 is a block diagram of the aerial vehicle according to an exemplary embodiment of the present invention. The steps S102 and S106 in FIG. 4 are similar to those of the aforementioned anti-collision method 100 of the UAV. The difference between the aerial vehicle 10 in FIG. 5 and the aerial vehicle 10 in FIG. 3 is that the aerial vehicle 10 in FIG. 5 further includes a Global Position System (GPS) 16, for accessing the latitude and longitude coordinates of the location of the aerial vehicle 10, and the GPS 16 can transmit latitude and longitude coordinates of the current location of the aerial vehicle 10 to the wireless transmission module 12 of the aerial vehicle 10.

In the step S403, the wireless transmission module 12 is configured to transmit a first latitude and longitude coordinates of the location of the first aerial vehicle (e.g., the aerial vehicle 10), and receiving a second latitude and longitude coordinates from the second aerial vehicle (e.g., the aerial vehicle 200).

In the step S404, the processor 14 of the first aerial vehicle (e.g., the aerial vehicle 10) obtains a spacing distance (e.g., the spacing distance D1 in FIG. 3A) according to a signal strength of the second signal, the second latitude and longitude coordinates, and the first latitude and longitude coordinates, and determines whether the spacing distance D1 is less than a distance threshold value. When the processor 14 determines that the spacing distance D1 is less than the distance threshold value, executes the step 3106. When the processor 14 determines that the spacing distance D1 is not less than the distance threshold value, returns to the step S102.

In an exemplary embodiment, as shown in FIG. 3A, the wireless transmission module 12 of the aerial vehicle 10 is configured to periodically receive the latitude and the longitude coordinates from the aerial vehicle 20, and obtaining the direction of travel and the travelling speed of the aerial vehicle 20, the processor 14 of the aerial vehicle 10 determines if the aerial vehicle 10 and the aerial vehicle 20 will collide according to the direction of travel and the travelling speed of the aerial vehicle 10 and the direction of travel and the travelling speed of the aerial vehicle 20.

In an exemplary embodiment, the aerial vehicle 10 can obtain a GPS package data by the GPS 16, the GPS package data includes the latitude and longitude coordinates and the ground speed of the aerial vehicle 10. For instance, the aerial vehicle 10 can obtain the latitude and longitude coordinates and the ground speed of itself from the GPS package data, and determines the spacing distance (e.g., the spacing distance D1 in FIG. 3A) between the aerial vehicle 10 and the aerial vehicle 20 according to the signal strength of the second signal. Based on these data, the aerial vehicle 10 can determine whether the aerial vehicle 10 and the aerial vehicle 20 will collide more precisely.

In an exemplary embodiment, the aerial vehicle 10 can broadcast the GPS package data and the first signal by the wireless transmission module 12 of the aerial vehicle 10, to make all the other aerial vehicles (e.g., the aerial vehicle 20) inside the transmission range Ra of the wireless transmission module 12 receive the GPS package data. For instance, when the aerial vehicle 20 receives the GPS package data and the first signal broadcasted by the aerial vehicle 10, the aerial vehicle 20 can obtain the latitude and longitude coordinates and the ground speed of the aerial vehicle 10, and determines a spacing distance (e.g., the spacing distance D1 in FIG. 3A) between the aerial vehicle 10 and the aerial vehicle 20 according to a signal strength of the first signal, hence the aerial vehicle 20 can also assess the risk of collision more accurately base on the aforementioned data.

In an exemplary embodiment, the processor 14 of the aerial vehicle 10 can calculate the direction of travel and the travelling speed of the aerial vehicle 20 according to the latitude and longitude coordinates of the aerial vehicle 20 received at the last time point and the latitude and longitude coordinates of the aerial vehicle 20 received at the current time point. For example, the latitude and longitude coordinates of the aerial vehicle 20 received at the last time point is located to the east of the latitude and longitude coordinates of the aerial vehicle 20 received at the current time point, then the processor 14 of the aerial vehicle 10 can determine that the aerial vehicle 20 may be travelling to the east. Besides, when the processor 14 determines that the latitude and longitude coordinates of the aerial vehicle 20 has travelled 0.3 m in one second, then the processor 14 of the aerial vehicle 10 can figure out that the aerial vehicle 20 is travelling east at the speed of 0.3 m per second. Then the processor 14 of the aerial vehicle 10 compares the direction of travel and the traveling speed of the aerial vehicle 20 with the direction of travel and the traveling speed of the aerial vehicle 10, and refers to the signal strength of the second signal of the aerial vehicle 20, to determine the spacing distance (e.g., the spacing distance D1 in FIG. 3A) between the aerial vehicle 10 and the aerial vehicle 20. In this way, the processor 14 of the aerial vehicle 10 can accurately determine if the flight paths of the aerial vehicle 20 and the aerial vehicle 10 will intersect or not, and can determine if the aerial vehicle 20 and the aerial vehicle 10 will collide.

In an exemplary embodiment, the aerial vehicle 20 can also directly transmit the direction of travel and the traveling speed of itself to the aerial vehicle 10, for allowing the aerial vehicle 10 determining if the aerial vehicle 10 and the aerial vehicle 20 will collide.

In the step S106, the processor 14 of the aerial vehicle 10 adjusts a flight status of the first aerial vehicle (e.g., the aerial vehicle 10). Since the step is similar to the step S106 in FIG. 1, further description thereby is omitted for the sake of brevity.

From the aforementioned description, by accessing the latitude and longitude coordinates of the locations of the aerial vehicles 10 and 20, and data such as the corresponding signal strengths, the processor 14 can determine the spacing distance (e.g., the spacing distance D1 in FIG. 3A) between the aerial vehicle 10 and the aerial vehicle 20, for dynamically adjusting the flight paths of the aerial vehicle 10 and the aerial vehicle 20, to thereby prevent the collision between the aerial vehicle 10 and the aerial vehicle 20.

By the aforementioned technical solutions, the flight distance between multiple aerial vehicles can be accurately detected, when the flight distance between two aerial vehicles is too short, the present invention can adjust the flight path of at least one aerial vehicle for preventing the collision of the two aerial vehicle. Besides, the wireless transmission module herein can be implemented by a Bluetooth transmission module, since the Bluetooth transmission module has a power-saving feature, the present invention can keep the power-saving under the situation that the system broadcasts a plurality of times of the wireless signals.

The aforementioned technical solutions can use the aforementioned iBeacon distance detecting technology, that is, the aerial vehicle (e.g., the aerial photography UAV) can continuously transmit and receive the broadcasting of the Bluetooth signal, and detect the distance between multiple aerial vehicles according to the broadcasted signal strengths. In this way, when the signal strength from one aerial vehicle which is received by another aerial vehicle is increased along with the direction of travel, the processor can adjust the traveling speed to slow down or to hover until the signal strength of the other aerial vehicle is graduated weakened, to thereby prevent the collision between the two aerial vehicles.

What is claimed is:

1. An anti-collision system for an Unmanned Aerial Vehicle (UAV), comprising:
a first aerial vehicle, having:
a wireless transmission module, for transmitting a first signal of the first aerial vehicle and for receiving a second signal from a second aerial vehicle; and
a processor, for calculating a signal strength of the second signal to obtain a spacing distance between the first aerial vehicle and the second aerial vehicle, and determining whether the spacing distance is less than a distance threshold value;
wherein when the spacing distance is less than the distance threshold value, the processor adjusts a flight status of the first aerial vehicle.

2. The anti-collision system for the UAV of claim 1, wherein when the spacing distance is less than the distance threshold value and the signal strength is increasing along with a timestamp, the processor determines that the first aerial vehicle and the second aerial vehicle are going to collide.

3. The anti-collision system for the UAV of claim 2, wherein the flight status comprises a first direction of travel of the first aerial vehicle and a first traveling speed of the first aerial vehicle, the first signal comprises a first identification code of the first aerial vehicle, and the second signal comprises a second identification code of the second aerial vehicle.

4. The anti-collision system for the UAV of claim 3, wherein the first aerial vehicle further comprises:
a Global Position System (GPS), for accessing a first latitude and longitude coordinates of a location of the first aerial vehicle.

5. The anti-collision system for the UAV of claim 4, wherein the wireless transmission module is further configured to receive a second latitude and longitude coordinates of a location of the second aerial vehicle from the second aerial vehicle, and the processor obtains the spacing distance according to the signal strength of the second signal, the second latitude and longitude coordinates and the first latitude and longitude coordinates.

6. The anti-collision system for the UAV of claim 5, wherein the wireless transmission module is further configured to periodically receive the second latitude and longitude coordinates from the second aerial vehicle, and obtains a second direction of travel and a second traveling speed of the second aerial vehicle, and the processor determines whether the first aerial vehicle and the second aerial vehicle are going to collide according to the first direction of travel and the first vehicle traveling speed of the first aerial vehicle and the second direction of travel and the second traveling speed of the second aerial vehicle.

7. The anti-collision system for the UAV of claim 3, wherein when the spacing distance is less than the distance threshold value, the processor compares a magnitude of the first identification code with that of the second identification code, to control the first direction of travel and the first traveling speed of the first aerial vehicle.

8. The anti-collision system for the UAV of claim 3, wherein when the spacing distance is less than the distance threshold value, the processor compares a magnitude of a first Media Access Control (MAC) address of the first aerial vehicle with that of a second MAC address of the second aerial vehicle, to control the first direction of travel and the first traveling speed of the first aerial vehicle.

9. The anti-collision system for the UAV of claim 1, wherein the wireless transmission module continuously broadcasts a first Bluetooth signal, and receives a second Bluetooth signal from the second aerial vehicle; wherein, the wireless transmission module calculates the spacing distance according to a Bluetooth signal strength of the second Bluetooth signal; and wherein the first aerial vehicle is an aerial UAV.

10. The anti-collision system for the UAV of claim 1, wherein the processor obtains the signal strength of the second signal by detecting a Received Signal Strength Indication (RSSI) of the second signal, and wherein the wireless transmission module is a Bluetooth transmission module based on Bluetooth Low Energy (BLE).

11. An anti-collision method for a UAV, comprising:
transmitting a first signal of a first aerial vehicle and receiving a second signal from a second aerial vehicle; and
calculating a signal strength of the second signal to obtain a spacing distance between the first aerial vehicle and the second aerial vehicle, and determining whether the spacing distance is less than a distance threshold value;
when the spacing distance is less than the distance threshold value, a flight status of the first aerial vehicle is adjusted.

12. The anti-collision method for the UAV of claim 11, further comprising:
determining that the first aerial vehicle and the second aerial vehicle will collide when the spacing distance is less than the distance threshold value and the signal strength is increasing along with a timestamp.

13. The anti-collision method for the UAV of claim 12, wherein the flight status comprises a first direction of travel and a first traveling speed, the first signal comprises a first identification code of the first aerial vehicle, and the second signal comprises a second identification code of the second vehicle.

14. The anti-collision method for the UAV of claim 13, further comprising:
accessing a first latitude and longitude coordinates of a location of the first aerial vehicle by a Global Position System (GPS).

15. The anti-collision method for the UAV of claim 14, further comprising:
receiving a second latitude and longitude coordinates from the second aerial vehicle, and
obtaining the spacing distance according to the signal strength of the second signal, the second latitude and longitude coordinates and the first latitude and longitude coordinates.

16. The anti-collision method for the UAV of claim 15, further comprising:
periodically receiving the second latitude and longitude coordinates from the second aerial vehicle, and obtaining a second direction of travel and a second traveling speed of the second aerial vehicle, and
determining whether the first aerial vehicle and the second aerial vehicle are going to collide according to the first direction of travel and the first vehicle traveling speed of the first aerial vehicle and the second direction of travel and the second traveling speed of the second aerial vehicle.

17. The anti-collision method for the UAV of claim 13, further comprising:
when the spacing distance is less than the distance threshold value, comparing a magnitude of the first identification code with that of the second identification code, to control the first direction of travel and the first traveling speed of the first aerial vehicle.

18. The anti-collision method for the UAV of claim 13, further comprising:
when the spacing distance is less than the distance threshold value, comparing a magnitude of a first Media Access Control (MAC) address of the first aerial vehicle with that of a second MAC address of the second aerial vehicle, to control the first direction of travel and the first traveling speed of the first aerial vehicle.

19. The anti-collision method for the UAV of claim 11, wherein the processor obtains the signal strength of the second signal by detecting a Received Signal Strength Indication (RSSI) of the second signal, and wherein the first aerial vehicle transmits the first signal by a Bluetooth transmission module based on Bluetooth Low Energy (BLE).

20. The anti-collision method for the UAV of claim 11, further comprising:
continuously broadcasting a first Bluetooth signal, and receiving a second Bluetooth signal from the second aerial vehicle; and
calculating the spacing distance according to a Bluetooth signal strength of the second Bluetooth signal; and wherein the first aerial vehicle is an aerial UAV.
